(19) United States
(12) Patent Application Publication
(10) Pub. No.: US 2003/0181240 A1
(43) Pub. Date: Sep. 25, 2003

(54) Method of controlling gaming machine, gaming machine, and gaming machine control program

(75) Inventor: Toru Nagao, Tokyo (JP)

Correspondence Address: SUGHRUE MION, PLLC, 2100 PENNSYLVANIA AVENUE, N.W., WASHINGTON, DC, 20037, US

(73) Assignee: KONAMI CORPORATION

(21) Appl. No.: 10/392,860

(22) Filed: Mar. 21, 2003

(30) Foreign Application Priority Data
Mar. 22, 2002 (JP) P2002-081416
Sep. 10, 2002 (JP) P2002-264400

(51) Int. Cl. G06F 19/00

(52) U.S. Cl. 463/20

(57) ABSTRACT

A method for controlling a gaming machine of the invention includes a first step of successively displaying a plurality of symbols whose sequential relationship has been determined beforehand on symbol display sections, across one of which a winning line is provided; a second step of sequentially stopping the variable display operations at certain timings, manually or automatically; and a third step of alternately selecting a symbol from the group comprising the symbols stationarily displayed in the second step and a group of symbols satisfying a predetermined condition, the selected symbol to be stationarily displayed next on any of symbol display sections located on a specific winning line by means of sequential stoppage, so as to follow any of the symbols stationarily displayed in the second step. Processing pertaining to the first through third steps is repeated until the specific symbols are stationarily displayed on all the symbol display sections.

### BACKGROUND OF THE INVENTION

The invention relates to a game which effects matching of symbols, and more particularly, to a method of controlling a gaming machine, a gaming machine, and a program for controlling a gaming machine, which enable enhancement of player's expectation at the time of determination of a win or failure.

Gaming machines which enable matching of symbols have hitherto been known. For instance, Registered Utility Model No. 3063137 describes a gaming machine which successively displays a plurality of types of symbols including the concept of sequence. When symbols are aligned in a predetermined sequence, a win is achieved. In this gaming machine, a plurality of types of symbols are displayed on a plurality of display areas (e.g., a plurality of reels) while being changed. Next, such changes in the symbols are stopped. At this time, when a plurality of types of symbols including the concept of sequence are aligned in a predetermined sequence, a player achieves a win. In contrast, if the symbols have failed to be aligned, the player loses. As a result of use of symbols including the concept of sequence, the arrangement of symbols is given a meaning.

However, in the case of this gaming machine, the sequence (arrangement) of symbols acts as a mere condition for achieving a win and does not determine the relationship between symbols appearing on respective display areas (e.g., reels). Enhancement of the player's expectation and arousing the player's passion for gambling are key factors in the field of a game in which matching of symbols is performed. A mere change in conditions for achieving a win is not considered to easily enhance the player's expectation and passion for gambling.

### SUMMARY OF THE INVENTION

The invention aims at providing a method of controlling a gaming machine, a gaming machine, and a program for controlling a gaming machine, which enable stirring up of a player's expectation and passion for gambling, by means of imparting, to symbols which have been stopped immediately beforehand, the function of suggesting candidate symbols which are to be stationarily stopped next time.

In order to solve the aforesaid object, the invention is characterized by having the following arrangement.

(1) A method of controlling a gaming machine comprising:

a first step of variably displaying a plurality of symbols, whose sequential relationship is previously determined, on a symbol displaying regions across a winning line is provided;

a second step of stopping the variable display operation at predetermined timings manually or automatically; and

a third step of, subsequently to stopping and displaying a symbol of the symbols on a symbol displaying region of the symbol displaying regions located on a specific winning line, stopping and displaying a following symbol which satisfies a predetermined condition in terms of the sequential relationship with the preceding symbol on a symbol displaying region which is located on the specific winning line other than the preceding symbol displaying region, manually or automatically,

wherein the third step is repeated until the symbols are stopped and displayed on all the symbol displaying regions.

(2) The method according to (1), wherein the predetermined condition is that the sequential rank of the following symbol is higher or lower in rank than that of the preceding symbol.

(3) The method according to (1), wherein in the third step, the sequential rank of the first symbol which is already stopped is detected, and the second symbol to be stopped next is selected from the group of symbols higher or lower in rank than the detected sequential rank, or equal to the same, by lottery.

(4) A method of controlling a gaming machine, in which numerals from 0 to “m” (“m” is a natural number) are displayed on the first to Nth columns (N is a natural number higher than 1) and any symbol is selected for each of the respective columns by lottery, and in which a win or failure is determined by the selected numerals or a combination thereof on a predetermined winning line crossing the respective columns, the method comprising the steps of:

when one of numerals to be located on the winning line at n+1th column (n is a natural number, n+1≦N) is selected by lottery, selecting any numeral by lottery from a range from a numeral determined on the nth column (here “n” is a natural number; n≦N) to m, or a range from one to the numeral determined on the nth column (where “n” is a natural number; n≦N); and

determining a win when identical numerals have been selected for all the columns or when a specific combination is established by the selected numerals.

(5) The method according to (4), wherein an amount of gaming value to be paid for a player is determined based on a probability of the winning.

(6) A method of controlling a gaming machine, comprising:

a first step of successively displaying a plurality of symbols, including variable symbols whose relationship varies within a predetermined sequence range, in symbol display regions, across which a winning line is provided;

a second step of sequentially stopping the successively displaying operations at certain timings, manually or automatically;

a third step of determining the rank of the variable symbol from the sequence range when any one of the variable symbols is stopped and displayed on any of the symbol display regions located on a specific winning line; and

a fourth step of, subsequently to the third step, determining any rank from the rank range satisfying a predetermined condition with respect to the sequential rank of variable symbols that have already been determined through the third processing when the variable symbol is stopped and displayed on another symbol display region which is located on the specific winning line other than the first symbol displaying region,

wherein the second to fourth steps are repeated until the symbols are stopped and displayed on all the symbol displaying regions.

(7) The method according to (6), wherein the predetermined condition is that the sequential rank of a variable symbol stationarily displayed through the fourth step is higher or lower in rank than that of the variable symbol determined in the third step.

(8) The method according to (6), wherein, in the fourth step, the sequential rank of the variable symbol determined in the third step is detected, and the sequential rank of a variable symbol which comes to a standstill after the third step is determined within the range higher or lower than the thus-detected rank, or equal to the same, by lottery.

(9) The method according to (6), wherein an amount of gaming value to be paid for a player is determined based on a probability of the winning.

(10) A method for controlling a gaming machine which displays a plurality of symbols, including variable symbols whose numerical values vary within the range from 0 to “m” (“m” is a natural number), on first through Nth columns (N is a natural number higher than 1); selects any one symbol for the respective columns by lottery; further selects a numeral from the range by lottery when the variable symbol has been selected by lottery; and determines a win or failure in accordance with the determined numerals or a combination thereof, the method comprising the step to:

detecting a numeral of the variable symbol in the column for which lottery is performed immediately beforehand when the variable symbol is selected for any one of the columns by lottery;

determining a numeral of the variable symbol in the column from a range from the detected numeral to “m” or the range from 1 to the detected numeral; and

determining achievement of a win when variable symbols having identical numerals is selected on all the columns or when the symbols have constituted a predetermined combination.

(11) The method according to (10), wherein an amount of gaming value to be paid for a player is determined based on a probability of the winning.

(12) A gaming machine comprising:

a display section for successively displaying a plurality of symbols whose sequential relationship is determined beforehand on symbol display sections, across which a winning line is provided;

a stop unit for sequentially stopping the variable display operations at certain timings, manually or automatically; and

a control section for, subsequently to stopping and displaying a symbol on any of the symbol displaying regions located on a specific winning line by the stop unit, alternately selecting a symbol from the group comprising the symbol having been stopped by the stop unit and a group of symbols satisfying a predetermined condition in terms of the sequential relationship, the symbol to be stationarily displayed next on another symbol display region located on the specific winning line,

wherein processing of stopping the variable display and selecting the symbol is repeated until the symbols are stationarily displayed on all the symbol display regions.

(13) The gaming machine according to (12), wherein the predetermined condition is that the sequential rank of the symbol having been stopped and displayed is higher or lower in rank than that of the symbol which has been stopped already.

(14) The gaming machine according to (12), wherein the control section detects the sequential rank of the symbol that has already been stopped and displayed by the stop unit, and a symbol to be stopped next is selected from the group of symbols higher or lower in rank than the detected sequential rank, or equal to the same, by lottery.

(15) A gaming machine comprising:

display sections for displaying numerals from 0 to “m” (“m” is a natural number) on first to Nth columns (N is a natural number higher than 1);

a lottery device for selecting any symbols for the respective columns by means of lottery; and

a control section for determining a win or failure in accordance with the selected numerals or a combination thereof on a specific winning line crossing the respective columns, wherein

the lottery device selects any numeral to be located on the specific winning line by lottery from a range from a numeral determined on the nth column (here “n” is a natural number; n≦N) or a range from one to the numeral determined on the nth column (where “n” is a natural number; n≦N) when any one is selected from the n+1th column (“n” is a natural number; n+1≦N) by lottery; and

the control section determines a win when identical numerals have been selected for all the columns on the specific winning line or when a specific combination is established by the numerals selected for the respective column.

(16) A gaming machine, comprising:

display sections for successively displaying a plurality of symbols, including variable symbols whose relationship varies within a predetermined sequence range, a wining line being provided across the display sections;

a stop unit for sequentially stopping the successively displaying operations at certain timings, manually or automatically; and

a control section for determining the sequential rank of the variable symbols from the sequence range when any one of the variable symbols are stationarily displayed in any of the symbol display sections located on a specific winning line when any of the variable symbols is stopped and displayed on any of the symbol display regions located on a specific winning line by the stop unit, and selecting the sequential ranks of variable symbols that have already been determined through the third processing and the rank range satisfying a predetermined condition from the sequence range when the variable symbol is stationarily displayed in another symbol display area sharing a winning line identical with the specific winning line,

wherein processing of stopping variable display and determining the sequential ranks is repeated until the symbol is stopped and displayed in all the symbol display sections.

(17) The gaming machine according to (16), wherein the predetermined condition is that the rank of a variable symbol to be stationarily displayed is higher in rank than or equal to the determined variable symbol or lower in rank than or equal to the same.

(18) The gaming machine according to (15), wherein the control section detects the sequential rank of the variable symbol determined already, and determines the sequential rank of a variable symbol which comes to a standstill after the variable symbol whose sequential rank is already determined is determined within the range higher or lower than the thus-detected sequential rank, including the same, by lottery.

(19) A gaming machine comprising:

a display section for displaying a plurality of symbols, including variable symbols whose numerical values vary within the range from 0 to “m” (“m” is a natural number), on first through Nth columns (N is a natural number higher than 1);

a lottery device for selecting any one symbol for each the respective columns by lottery and further selecting a numeral from the range by lottery when the variable symbol has been selected by lottery; and

a control section for determining a win or failure in accordance with the determined numerals or a combination thereof,

wherein the lottery device detects a numeral of the variable symbol in the column for which lottery has been performed immediately before the variable symbol has been selected for any one of the columns by lottery and determines a numeral of the variable symbol in the column from a range from the detected numeral to “m” or the range from 1 to the detected numeral, and

wherein the control section determines achievement of a win when variable symbols having identical numerals are selected on all the columns crossing a specific winning line or when value of the variable symbols selected for respective columns constitutes a predetermined combination.

(20) The gaming machine according to (19), wherein an amount of gaming value to be paid for a player is determined based on a probability of the winning.

(21) A gaming machine comprising:

a display section for successively displaying a plurality of symbols whose sequential relationship is determined beforehand on symbol display sections, across which a winning line is provided;

a stop unit for sequentially stopping the variable display operations at certain timings, manually or automatically; and

a control section for, subsequently to stopping and displaying a symbol on any of the symbol displaying regions located on a specific winning line by the stop unit, alternately selecting a symbol from the group comprising the symbol having been stopped by the stop unit and a group of symbols satisfying a predetermined condition in terms of the sequential relationship, the symbol to be stationarily displayed next on another symbol display region located on the specific winning line,

wherein processing of alternately selecting the symbol to be displayed on the symbol display region is repeated until the symbols are stopped and displayed on all the symbol display regions.

(22) A gaming machine comprising:

display sections for successively displaying a plurality of symbols, including variable symbols whose relationship varies within a predetermined sequence range, a wining line being provided across the display sections;

a stop unit for sequentially stopping the successively displaying operations at certain timings, manually or automatically; and

a control section for alternatively selecting a sequential rank of a-variable symbol to be stopped at any one of the symbol display region located on a specific winning line, and alternatively selecting the sequential rank of a variable symbol to be stopped at another symbol display region sharing the specific winning line from the group comprising the sequential rank of the variable symbol to be stopped and the sequence range satisfying a predetermined condition in terms of the sequential relationship,

wherein processing of alternatively selecting symbol is repeated until the symbol is stopped and displayed in all the symbol display sections.

(23) A computer readable recording medium for causing a gaming machine including a computer to execute:

first processing for variably displaying a plurality of symbols, whose sequential relationship is previously determined, on a symbol displaying regions across which a winning line is provided;

second processing for stopping the variable display operation at predetermined timings manually or automatically; and

third processing for, subsequently to stopping and displaying a symbol of the symbols on a symbol displaying region of the symbol displaying regions located on a specific winning line, stopping and displaying a following symbol which satisfies a predetermined condition in terms of the sequential relationship with the preceding symbol on a symbol displaying region which is located on the specific winning line other than the preceding symbol displaying region, manually or automatically,

wherein the third processing is repeated until the symbols are stopped and displayed on all the symbol displaying regions.

### BRIEF DESCRIPTION OF DRAWINGS

FIG. 1 is a perspective view showing a gaming machine according to an embodiment of the invention;

FIG. 2 is a diagram showing an electrical configuration of the gaming machine;

FIG. 3 is a diagram showing the layout of respective symbol display sections;

FIG. 4 is a main flow of a control program of the gaming machine;

FIG. 5 is a diagram showing pay lines;

FIG. 6 is a flowchart showing a processing operation for stopping spinning reels;

FIG. 7 is a flowchart showing a processing operation for stopping spinning reels; and

FIGS. 8A and 8B are diagrams showing display statuses of respective symbol display sections.

### DETAILED DESCRIPTION OF PREFERRED EMBODIMENTS

Gaming machines according to embodiments of the invention will be described hereinbelow. The invention can be applied to any machine which enables sequential stoppage of symbols of respective columns (i.e., a machine which effects a game), by means of successively displaying a plurality of rows of symbols. Mechanical reels may be used for sections which successively display symbols, or there may be employed a video reel which successively displays symbols as images on a liquid-crystal screen or the like. Further, the invention can be applied to a gaming machine which automatically and sequentially stops reels regardless of the player's intention, in the manner of a pachinko machine, as well as to a gaming machine which enables a player to actuate stop buttons at his/her own will, thereby determining stop timings of respective reels and a sequence in which the reels are to be stopped. Moreover, the embodiments describe the invention while medals are taken as an example of gaming value medium. However, this does not mean that the gaming value medium of the invention should be limited to the embodiments. Any medium capable of affording a gaming value, such as pachinko balls, corresponds to the gaming value medium.

First Embodiment

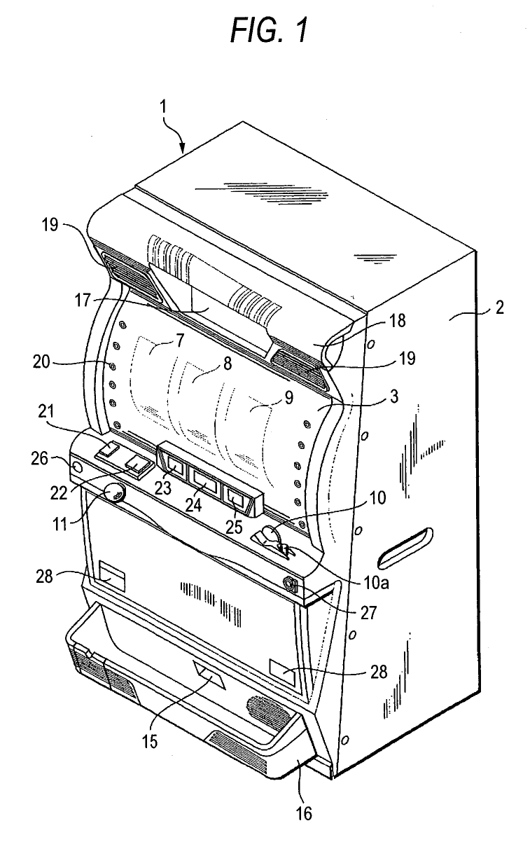

As shown in FIG. 1, a gaming machine 1 is constituted by a housing 2; and a front panel 3 which is removably attached to the front of the housing 2. Symbol display sections 7 through 9 are provided on the back of the front panel 3. The symbol display sections 7 through 9 are constituted by a liquid-crystal panel or a CRT (cathode ray-tube) and display symbols in three columns, for example. The embodiment adopts a video reel method. Various symbols can be displayed on the respective symbol display sections 7 to 9 by means of execution of a program. Provided on the front panel of the housing 2 are a medal insert slot 10; and a medal return button 10a to be used for returning medals when inserted medals have become clogged. A start lever 11 is to be actuated for starting rotational display of the respective symbol display sections 7 to 9.

A game to be played on this gaming machine 1 is started when the player specifies one or more active winning lines (i.e., pay line(s)) by means of betting operation. Here, a plurality of active lines, such as a center horizontal line, an upper horizontal line, a lower horizontal line, and oblique lines, can be set as active lines. As will be described later, the betting operation can be performed by insertion of medals into the medal inset slot 10 or by betting medals performed by a reserved medal insert button 21. Further, the betting operation can be performed by combined usage of these betting operations.

When one or more active lines are specified by a player's betting operation and the start lever 11 is actuated, the symbol display sections 7 to 9 successively display symbols. After lapse of a predetermined period of time, the symbol display sections 7 to 9 sequentially stop the display changing operations. A sequence in which the symbol display sections are to be stopped is, for example, in order of symbol display sections 7, 8, and 9. When a predetermined combination of symbols is displayed along any one of the active winning lines at the time of stoppage of the symbol display sections 7 to 9, a win corresponding to the combination of symbols is achieved.

A medal payout port 15 and a medal receiver 16 are provided at lower positions on the front panel 3. A game presentation indicator 17 which operates for providing game presentation is provided at an upper position on the front panel 3. The game presentation indicator 17 is constituted of, e.g., LCDs (Liquid Crystal Device) or various lamps. The embodiment shows an example adopting an LCD. A bonus game indicator 18 is provided at an elevated position on the front panel 3. The bonus game indicator 18 is constituted of LEDs and shows occurrence or achievement of a bonus win for affording high gaming value to the player, game presentation, occurrence of an error, and occurrence of a play-end state. Speakers 19 generate a voice guide, music, or sound effects. Incidentally, when a bonus win has been achieved, a game proceeds in a manner advantageous to the player; for example, such that a winning percentage assumes a value of one-third.

A plurality of lamps 20 provided on the front panel 3 provide a display pertaining to a game, such as a display of active lines (pay lines) which have been rendered active in accordance with the number of inserted medals or a display of a win, by means of illumination, extinction, or blinking. The reserved medal insert button 21 is for using only a predetermined number of medals reserved in an unillustrated medal reservoir. A reserved medal insert button 22 is for using a maximum specified number of medals reserved in an unillustrated medal reservoir. A reserved medal count indication section 23 displays the number of medals reserved in an unillustrated medal reservoir. A win count display section 24 displays the number of wins achieved at the time of achievement of wins or the number of remaining achievable wins at the time of occurrence of a bonus win. A medal-to-be-paid count display section 25 displays the number of medals paid. The reserved medal count display section 23, the win count display section 24, and the medal-to-be-paid count display section 25 are constituted of, e.g., LEDs. A settlement button 26 performs settlement of reserved medals. A lock device 27 unlocks a door when turned in an unlocking direction. A label 28 describes the model of the slot machine 1 and the name of a manufacturer.

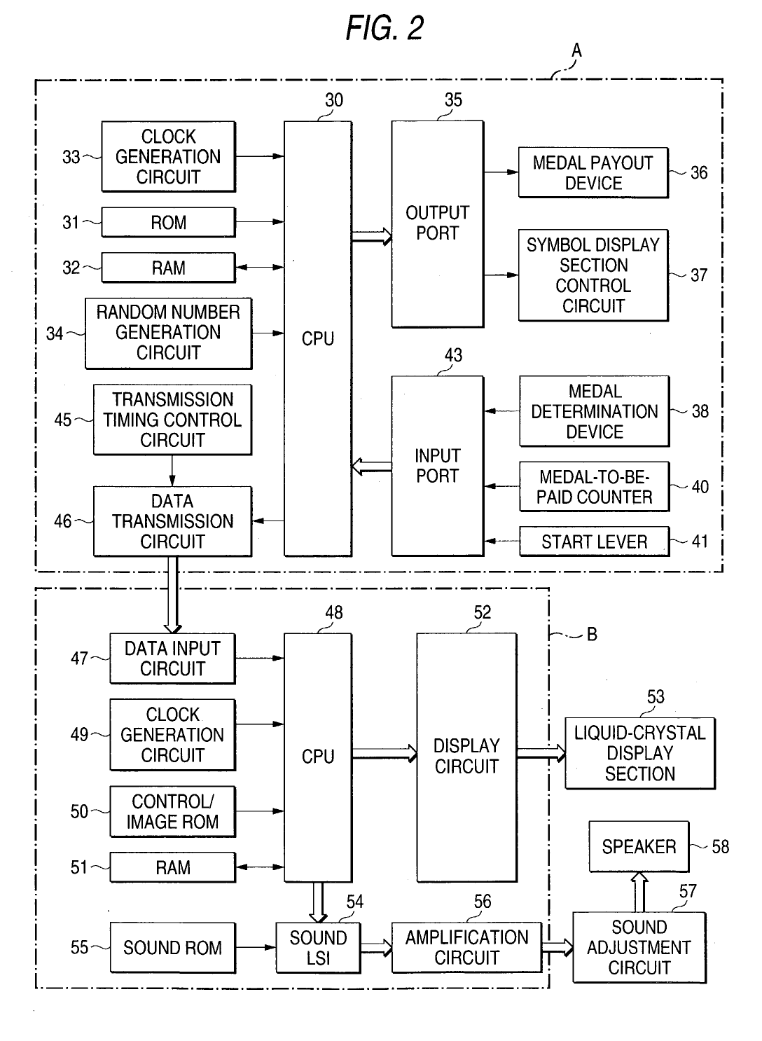

FIG. 2 is a diagram showing an electrical configuration of a gaming machine of the embodiment. As shown in FIG. 2, the gaming machine 1 is electrically constituted by a main board A and a sub-board B. In the main board A, a CPU 30 includes ROM 31 and RAM 32 and performs a control operation in accordance with a preset program. The ROM 31 stores a prize group lottery table for preliminary determining (internal lottery) a group of prizes, and a control program for controlling the operation of the gaming machine 1. The CPU 30, the ROM 31, and the RAM 32 constitute a stop unit and a control section.

The CPU 30 is connected to a clock generation circuit 33 for producing a reference clock pulse and to a random number generation circuit 34 for generating a predetermined random number. The CPU 30 and the random number generation circuit 34 constitute a random lottery device a control signal transmitted from the CPU 30 is output through an output port 35, to a medal payout device 36 for paying medals, and to a symbol display section control circuit 37 for controlling the symbol display sections 7 to 9. The symbol display sections 7 to 9 and the symbol display section control circuit 37 constitute a display section serving as a symbol display region. The CPU 30 and the medal payout device constitute a payout device.

A signal output from a medal determination device 38 for identifying whether or not a medal is appropriate, a signal output from a medal counter 40 for counting the number of medals paid, and a signal output from a start lever 41 for starting spinning of the reels are input to the CPU 30 through an input port 43. A signal output from the CPU 30 is output to the sub-board B through a data transmission circuit 46 under control of a transmission timing control circuit 45, which controls a timing at which a signal is to be transmitted to the sub-board B.

In the sub-board B, a signal output from the data transmission circuit 46 is input to a data input circuit 47. The signal input to the data input circuit 47 is processed by a CPU 48. The CPU 48 is connected to a clock generation circuit 49, which produces a reference clock pulse, and to ROM 50 and RAM 51 having various programs and image data recorded thereon. Data pertaining to images are output from the CPU 48 to a liquid-crystal indicator 53 by way of a display circuit 52, which performs an image processing operation. The liquid-crystal indicator 53 displays characters, static images, motion pictures, or the like. Data pertaining to voice are output to an amplification circuit 56 from the CPU 48 by way of a sound LSI 54, which performs sound processing. The sound LSI 54 processes sound data by extraction of required sound data from sound ROM 55. The sound data are subjected to processing, such as amplification, in the amplification circuit 56 and are output to a speaker 58 by way of a sound adjustment circuit 57.

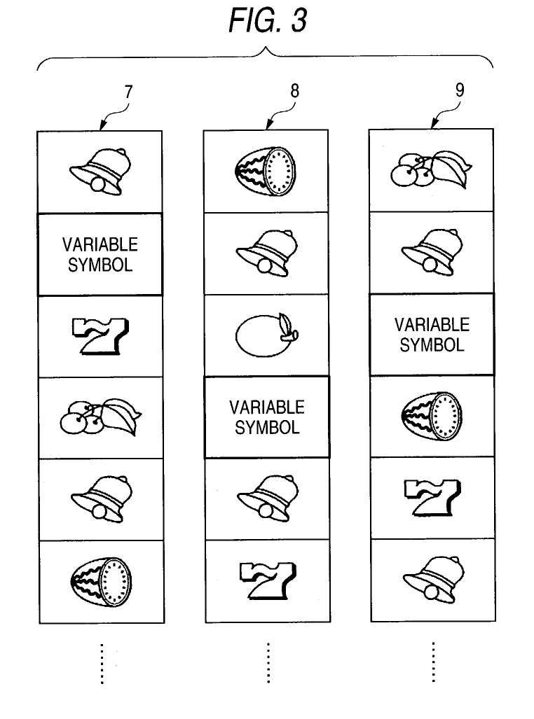

With reference to FIG. 3, symbols appearing on the symbol display sections 7 to 9 will be described. As shown in FIG. 3, each of the symbol display sections 7 to 9 can display a variable symbol; e.g., a variable symbol of numerals 0 to 9, and other symbols (e.g., “7,”, “BELL,” and “PLUM”). When a game is started, the symbol display sections 7 to 9 successively display the symbols. The variable symbol does not only display images but also display numerous values that are displayed while changing. When the game starts, the symbol display sections 7 to 9 starts variably displaying these symbol. After lapse of a predetermined period of time, the symbol display sections 7, 8, and 9 stop variable displaying actions, in this order. When a variable symbol has come to a standstill at an active line (i.e., a pay line) in the symbol display section 7, any one numeral value is selected from the range of 0 to 9 by lottery and the thus-selected value is determined. Next, when a variable symbol has come to a standstill at an active line (i.e., a pay line) in the symbol display section 8, one numeral which is equal to or greater than that selected in the symbol display section 7 and falls within the range of 0 to 9 is determined by lottery system. Next, when a variable symbol has come to a standstill at an active line (i.e., a pay line) in the symbol display section 9, one numeral which is equal to or greater than that selected in the symbol display section 8 and falls within the range of 0 to 9 is determined by the lottery system.

Incidentally, when operating the gaming machine 1, the selection is performed at the moment of operating the start lever 11. Namely, at the moment of operating the start lever 11, the symbol to be displayed and stopped on the symbol display sections 7 to 9 is determined by the selection. When the variable symbol is to be displayed and stopped according to the result of the selection, the further selection is performed to determine the numeral from the range of 0 to 9. Specifically, it is determined to display and stop the variable symbol on the active line (i.e. pay line) of the symbol display section 7 according to the selection, one numeral is determined from the range of 0 to 9. Further, it is determined to display and stop the variable symbol on the active line (i.e. pay line) of the symbol display section 8 according to the selection, one numeral which is equal to or greater than the numeral determined at the symbol display section 7 and falls within range of 0 to 9 is determined. Further, it is determined to display and stop the variable symbol stand still on the active line (i.e. pay line) of the symbol display section 9 according to the selection, one numeral which is equal to or greater than the numeral determined at the symbol display section 8 and falls within range of 0 to 9 is determined. For these determining processing, the CPU 30 executes the program while transmitting and receiving the signal to and from the ROM 31, RAM 32 and the random number generating circuit 34. Therefore, these processing is performed in an instant.

In this way, the variable symbol performs a variable display by means of changing a numeral, as well as merely displaying symbols. A selecting operation is performed such that numerals greater than those displayed immediately in the symbol display sections are inevitably displayed. For instance, when a variable symbols comes to a stop at a pay line in the symbol display section 7 that stops a symbol first, the variable symbol is presumed to assume a value of “5” or more. In this case, a variable symbol comes to a halt at the pay line in the symbol display section 8, and a numeral falling within the range of 5 to 9 is selected by selecting operation. Accordingly, for instance, numerals which appear on the symbol display sections 7 to 9 do not assume a combination of “5-4-3.”

Progress in a game may be changed in accordance with a combination of specific numerals. For example, when a predetermined combination of numerals; that is, “3-5-7” or #5-7-9#, is aligned, a game may proceed to a high-probability game in which the probability of occurrence of a win through internal selecting operation becomes high. In the next game and subsequent games, there may be provided presentation which enables a player to play five games without charge. Alternatively, there may be adopted another mode of a win, in which a win is determined regardless of presence of an activated winning line when certain symbols are aligned into a certain layout while being scattered over the display sections. For instance, when “7” symbols are aligned in the shape of the letter V, achievement of a win may be determined. In the embodiment, when identical numerals, such as “5-5-5,” have come to a standstill on the respective symbol display sections 7 through 9, achievement of a win is determined.

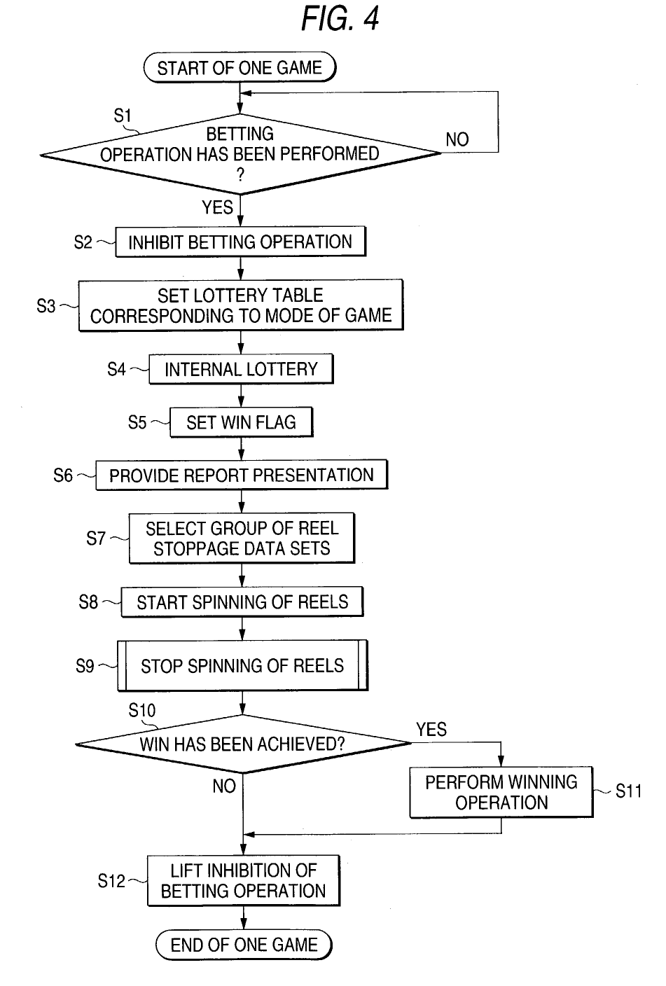

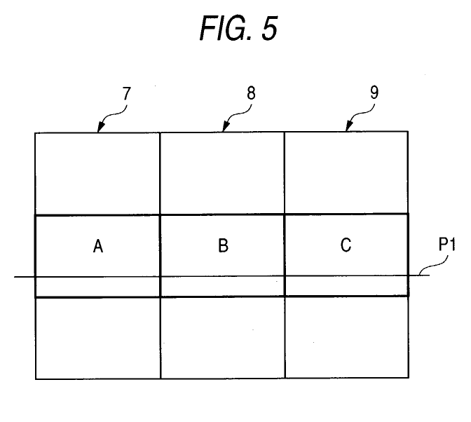

The operation of the gaming machine 1 will now be described. FIG. 4 is a main flow of a control program which controls operation of the gaming machine 1. The game is started by means of a player's betting operation. First, a determination is made as to whether or not a betting operation has been performed (step S1). Here, the player can insert one medal. As a result of insertion of a medal, a winning line (pay line) is activated. FIG. 5 is a view showing the symbol display sections 7 through 9. As shown in FIG. 5, when the player performs a betting operation, the center horizontal line P1, for example, acts as a pay line. In contrast, when no betting operation is performed, a determination operation pertaining to step S1 is repeated. When a betting operation is performed, the betting operation is inhibited (step S2), thereby determining an active line. Next, a lottery table corresponding to the mode of a game (e.g., an ordinary game or a bonus game) is set (step S3), whereby internal selecting operation is performed (step 54) A win or failure is determined by internal selecting operation (step S4). When a win has been determined for any one of prize groups, a win flag is set (step S5), and a report presentation operation is performed (step S6). For example, when a win for a bonus prize has been achieved through internal selecting operation performed in step S4, achievement of a bonus prize is reported by sound, a screen display, or sound effects. In step S7, a group of reel stop data sets to be used for controlling stoppage of the respective symbol display sections 7 to 8 are selected, thereby starting spinning (variable display) of the reels (i.e., the symbol display sections 7 to 9) (step S8). Next, spinning actions of the reels (i.e., symbol display sections 7 through 9) are stopped (step S9).

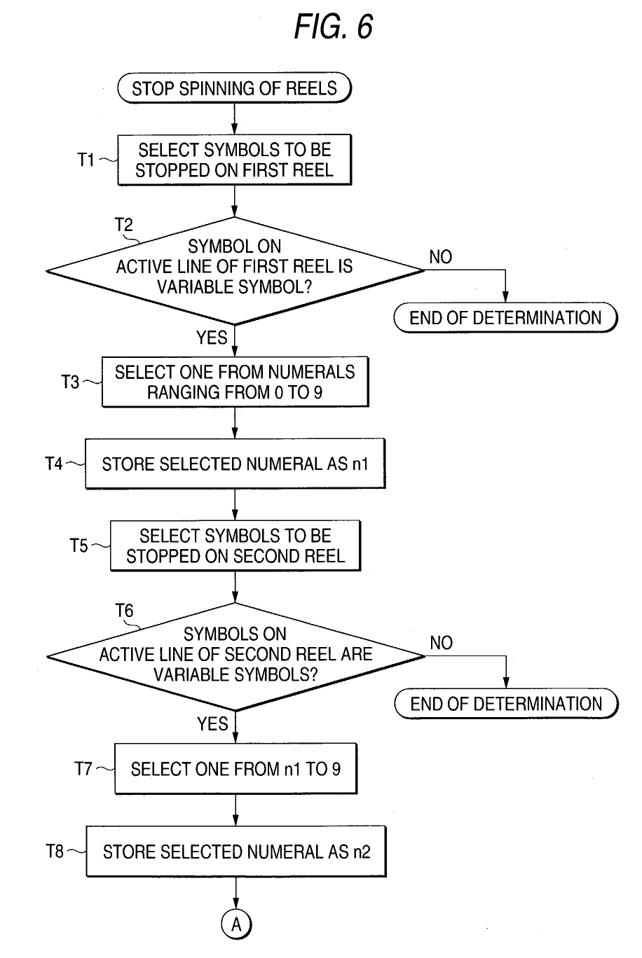

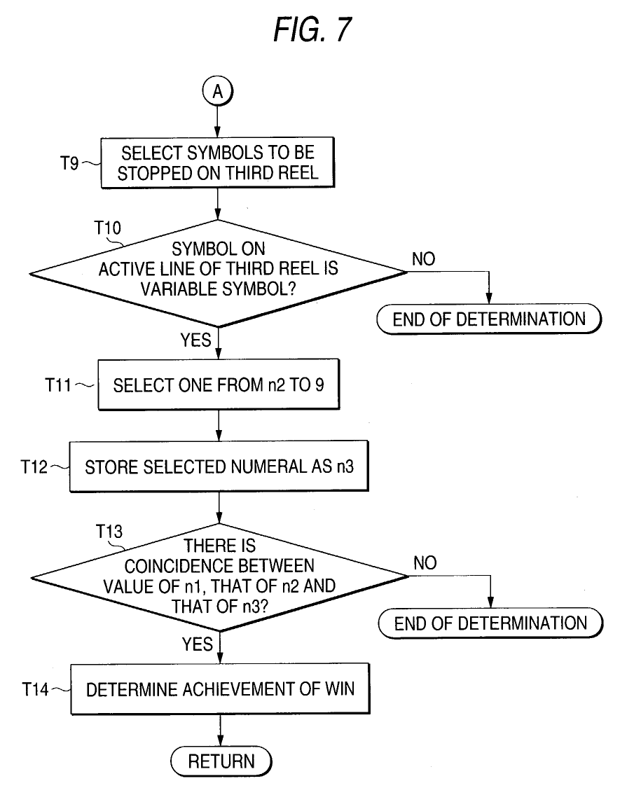

Stoppage of spinning reels is performed in accordance with a flowchart shown in FIGS. 6 and 7. First, a symbol on the first reel (i.e., the symbol display section 7) to be stopped at an activated winning line (pay line) is determined (step T1), and the symbol is displayed on the pay line. Next, a determination is made as to whether or not the symbol appearing on the pay line is a variable symbol (step T2). If a result of determination shows that the symbol is not a variable symbol, the determination operation is terminated, and processing returns to step S9. In contrast, if in step T2 the symbol is determined to be a variable symbol, any one numeral is selected from the range of 0 to 9 (step T3). The numeral selected in step T3 is stored as a value n1 (step T4).

Next, a symbol on the second reel (i.e., the symbol display section 8) to be stopped at an activated winning line (pay line) is determined (step T5), and the symbol is displayed on the pay line. Next, a determination is made as to whether or not the symbol appearing on the pay line is a variable symbol (step T6). If a result of determination shows that the symbol is not a variable symbol, the determination operation is terminated, and processing returns to step S9. In contrast, if in step S9 the symbol is determined to be a variable symbol, any one numeral is selected from the range of 0 to 9 (step T7). The numeral selected in step T7 is stored as a value n2 (step T8).

Next, a symbol on the third reel (i.e., the symbol display section 9) to be stopped at an activated winning line (pay line) is determined (step T9), and the symbol is displayed on the pay line. Next, a determination is made as to whether or not the symbol appearing on the pay line is a variable symbol (step T10). If a result of determination shows that the symbol is not a variable symbol, the determination operation is terminated, and processing returns to step S9. In contrast, if in step T10 the symbol is determined to be a variable symbol, any one numeral is selected from the range of 0 to 9 (step T11). The numeral selected in step T11 is stored as a value n3 (step T12).

A determination is then made as to whether or not the thus-obtained values of n1, n2, and n3 are coincident with each other (step T13). If a result of determination shows that no coincidence exists among the values, a determination is terminated, and processing returns to step S9. In contrast, if a coincidence is determined to exist among the values in step T12, a win is determined to have been achieved (step T14), and processing returns to step S9.

When an operation for stopping spinning reels is completed in step S9, a determination is made as to whether or not a win for a prize group has been achieved (step S10). Here, a win means achievement of a win or accomplishment of a win by a combination of symbols other than variable symbols in step T14. If accomplishment of a win has failed, processing proceeds to step S12, whereby a win flag is cleared. On the other hand, if a win has been achieved, win processing is performed (step S11). During win processing, payment of medals and addition of the number of reserved medals are performed. Next, inhibition of a betting operation is lifted (step S12), thereby completing the game.

As mentioned above, when the variable symbol has been selected for the symbol display section 7 by the selecting operation, a value of n1 is selected. If the variable symbol has been selected for the symbol display section 8 by the selecting operation, a value of n2 is selected for the variable symbol by the symbol display section 8 from the range of n1 to 9 (a maximum of “m”). As a result, the range of lottery becomes narrower, and the player can more easily predict a numeral which can be determined by the symbol display section 8. When the symbol display section 9 has selected a variable symbol by the selecting operation, a numeral of variable symbol for the symbol display section 9 is determined from the range of n2 to 9 (a maximum of “m”). As a result, the range of lottery becomes narrower. Hence, the player can more easily to predict a numeral to be determined by the symbol display section 9. Consequently, the player's expectation for a win is enhanced, thereby stirring up the player's passion for gambling.

The above-described description shows an embodiment in which, when a variable symbol has been selected by any one of the symbol display sections, a numeral for the variable symbol is determined by the selecting operation (lottery) so that the numeral is selected from the range of a numeral for the variable symbol in the symbol display section which has been selected immediately before hand, to a maximum value “9”. Alternatively, a numeral for a variable symbol to be displayed in the symbol display section may be selected from the range of a minimum numeral “1” to the numeral of the variable symbol appearing in the symbol display section which has been selected immediately beforehand.

Second Embodiment

A second embodiment of the invention will now be described. In the first embodiment, the symbol display sections 7 through 9 have chosen numerals under the selecting operation (lottery) when the variable symbols are displayed and stopped on the pay line, but the symbol display sections 7 through 9 may directly display numerals as symbols. In short, ten numeral symbols 0 through 9 are used as symbols. Each of the symbol display sections 7 through 9 successively displays numerals from 0 to 9. The symbol display sections 7 through 9 successively display numerals from among 0 to 9, respectively, and the symbol display sections 7, 8, and 9 stop, in this order, variable display of the symbols. When the symbol display section 7 stops the symbol, any numeral n1 is selected from 0 to 9, by the selecting operation (lottery). Next, when the symbol display section 8 stops the symbol, any numeral n2 is selected from the range of n1 to 9, by the selecting operation (lottery). Further, when the symbol display section 9 stops the symbol, any numeral n3 is selected from the range of n2 to 9, by the selecting operation (lottery). When n1, n2, and n3 assume identical numbers, a win is attained. Here, the probability of occurrence of a win in the game is (1/10)×(1/10)×(1/10)=1/1000.

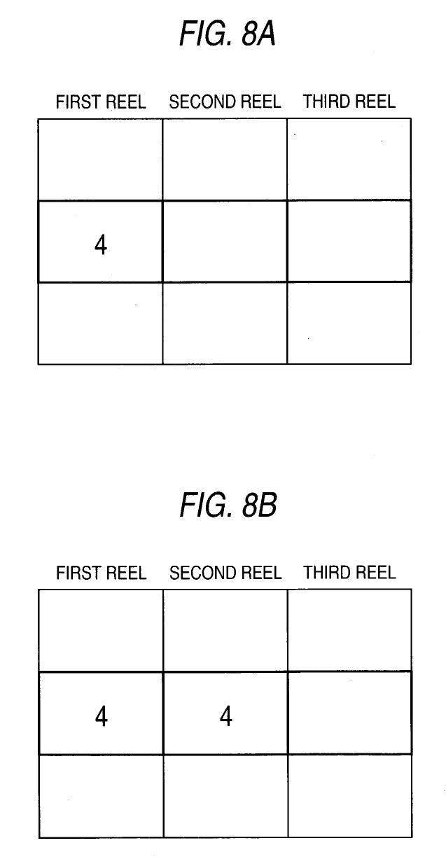

As shown in FIG. 8A, for example, a symbol on the first reel is stopped, to thereby display “4”. At this point in time, the number of symbols which can be stopped on the second reel is understood to be six; that is, any of 4 through 9 can be displayed. At this point in time, the remaining probability of achievement of a win is not (1/10)×(1/10)=1/100 but (⅙)×(⅙)=1/36. As shown in FIG. 8B, when the second reel is stopped, to thereby display “4”, the number of symbols which can be stopped on the third reel at this point time are six; that is, any of 4 to 9 can be displayed. At this point in time, the probability of achievement of a win is not one in ten but one in six. At this time, the symbol to be stopped on the third reel does not assume any one of 0 through 3. In contrast, when any one of numerals from 5 to 9 is stopped on the second reel, a failure arises.

When a win is achieved, number of medals to be paid for the player may be determined based on probability of the winning. That is, since numeral “4” is stopped on the first reel in the above example, winning probability is 1/369 at this time. However, when numeral “1” is stopped on the first reel, number of the symbols which can be stopped on the second reel is nine of 1 to 9 in this time. Accordingly, at this time, remaining winning probability is (1/9)×(1/9)=1/81. This probability is clearly lower than that in case that numeral “4” is stopped on the first reel. Therefore, the smaller the numeral stopped on the first reel, the winning probability become lower. In the gaming machine, when the win is achieved, the lower the winning probability, number of medals to be paid for the player increases.

When any value is selected from the n+1^{th} column (where “n” is a natural number; and n+1≦3) by the selecting operation (lottery), any numeral may be selected by the selecting operation from the range from 1 to the numeral determined by the n^{th} column (where “n” is a natural number; n≦2).

As mentioned above, when a numeral is displayed on the n^{th} column at the active pay line, a numeral to be displayed on the n+1^{th} (“n” is a natural number) is determined from the range from the number determined by the n^{th} column to “m” or from the range from 1 to the number determined by the n^{th} column. The player can readily predict a numeral to be displayed on the n+1^{th} column. As a result, the player's expectation for a win is enhanced, and the player's passion for gambling can be stirred up.

In the above description, numbers or numerals are used as a concept representing a sequence. However, a sequence of symbols may be defined, and the thus-defined sequence may be used in place of numbers or numerals. In this case, a definition state is preferably provided on the front panel 3 of the gaming machine. For example, if cards are selected from among sequences commonly accepted in the world and thus-selected cards are used, an indication stating that “A” is the maximum and “2” is the minimum” is displayed as a sequence of symbols. Further, when a moving speed is used as a concept of sequence, an indication stating that “a rocket is the highest, and a turtle is the lowest” may be displayed. Alternatively, a sequence of “King>Queen>, . . . >Government Officer>Common People” may be displayed when the class system of a nation is used as a concept of sequence.

The foregoing characteristic operations of the gaming machine are performed by execution of the control program. The control program causes a gaming machine having a computer to perform first, second, and third processing operations. In the first processing operation, a plurality of symbols whose hierarchical relationship has been determined beforehand are successively displayed in symbol display sections, a cross which a winning line is provided. In the second processing operation, the variable display actions are sequentially stopped at certain timings, manually or automatically. In a third processing operation, a symbol is to be stationarily displayed in another symbol display section sharing the specific winning line, so as to follow any of the symbols which have already been stationarily displayed by the second processing. The symbol is selected alternatively from the symbol that has already been stationarily displayed through the second processing operation and a group of symbols satisfying a given condition. The first through third processing operations are iterated until the specific symbols are stationarily displayed on all the symbol display regions.

As mentioned above, a symbol—which is to be stationarily displayed in another symbol display section sharing specific winning line, so as to follow any of the symbols having already been stationarily displayed in any one of the symbol display sections—is selected alternatively from a group comprising the symbol that has already been stationarily displayed through the second processing operation and a group of symbols satisfying a given condition. When a symbol is displayed on any one of the display areas along an active line, the player's expectation for a symbol to be displayed next can be enhanced. Further, when a symbol has been stationarily displayed along an active winning line in any one of the display sections, the player can intuitively predict the probability of occurrence of a win by means of the symbols stopped in the display regions immediately beforehand. As a result, the player's expectation for achievement of a win is enhanced, and the player's motivation for winning can be stirred up.

The given condition of the control program for the gaming machine of the invention is characterized in that a symbol to be stationarily displayed so as to follow the symbol having been already been stopped is higher or lower, in sequential rank, than the symbol that has already been stationarily displayed through the second processing, or equal to the same.

As mentioned above, the symbol to be stationarily displayed so as to follow that having already been stationarily displayed is higher or lower in rank than the symbol having already been stationarily displayed or equal to the same. Hence, the player can readily predict a symbol to be stationarily displayed. As a result, the player's expectation for achievement of a win is enhanced, and the player's passion for gambling can be stirred up.

The control program for the gaming machine according to the invention is characterized in that the sequential rank of the symbol that has already been stationarily displayed through the second processing is detected, and a symbol to be stopped next is selected from the group of symbols higher or lower in rank than the thus-detected sequential rank, or equal to the same, by lottery.

As mentioned above, the sequential rank of the symbol that has already been stationarily displayed is detected. A symbol to be stationarily stopped next is selected from a group of symbols which are higher or lower the thus-detected sequential rank, or equal to the same, by lottery. Hence, the player can readily predict candidate symbols to be stationarily stopped next. As a result, the player's expectation for achievement of a win is enhanced, and the player's passion for gambling can be stirred up.

The control program for the gaming machine of the invention causes a gaming machine having a computer to display numerals ranging from 1 to “m” (“m” is a natural number) in the first column to the N^{th} column (N is a natural number), and to select one numeral from each of the columns by lottery. A win or failure is determined by means of the thus-selected numerals or a combination thereof. The program causes the computer to perform two processing operations. In one processing operation, when any one numeral is selected from the n+1^{th} column (“n” is a natural number; n+1≦N) by lottery, any numeral is selected from the range from the numeral determined by the n^{th} column (“n” is a natural number; n≦N) to “m” or the range from one to the numeral determined by the n^{th} column (“n” is a natural number; n≦N). In another processing operation, a win is achieved when identical numerals have been selected for all the columns or when the thus-selected numerals constitute a specific combination.

In this way, when a numeral is displayed on the n^{th} column at the winning line, a numeral to be displayed in the n+1^{th} column (“n” is a natural number) is determined through lottery from the range from the n^{th} numeral to “m” or from the range from one to the n^{th} numeral. Hence, the player can readily predict the numeral to be displayed on the n+1^{th} column. As a result, the player's expectation for achievement of a win is enhanced, and the player's passion for gambling can be stirred up.

The control program fort he gaming machine of the invention causes a gaming machine having a computer to perform first through fourth processing operations. In the first processing operation, a plurality of symbols, including variable symbols whose relationship varies within a predetermined sequence range, are successively displayed in symbol display sections, across which a winning line is provided. In the second processing operation, the successively displaying operations are sequentially stopped at certain timings, manually or automatically. In the third processing operation, when any one of the variable symbols is stationarily displayed in any of the symbol display sections located on a specific winning line as a result of a sequential stoppage operation, the rank of the variable symbol is determined from the range of sequence. In the fourth processing operation subsequent to the third processing operation, when the variable symbol is stationarily displayed in another symbol display section sharing a winning line identical with the specific winning line, the sequential ranks of variable symbols that have already been determined through the third processing and the rank range satisfying the given conditions are determined from the sequence range. The first through fourth processing operations are iterated until the symbols are stationarily displayed in all the symbol display sections.

As mentioned above, if a certain variable symbol is stationarily displayed, to thereby determine any sequence of the variable symbol, and if another variable symbol is stationarily displayed, a sequential rank of the variable symbol determined immediately beforehand and a rank satisfying a given condition are determined. When a rank of a variable symbol in any one of the display areas has been determined, the player's expectation for a rank which would be determined when another variable symbol is stationarily displayed can be enhanced. Further, the player can intuitively predict the probability of a win from the rank of the variable symbol determined immediately beforehand. Consequently, the player's expectation for achievement of a win is enhanced, and the player's passion for gambling can be stirred up.

The control program for the gaming machine of the invention is characterized in that the given condition is that the sequential rank of a variable symbol stationarily displayed through fourth processing is higher or lower than the sequential rank of the variable symbol determined through the third processing or equal to the same.

As mentioned above, the sequential rank of the variable symbol to be stationarily displayed is higher or lower than the sequential rank of the variable symbol that has already been determined Or equal to the same, whereby the player can easily predict a symbol to be stationarily displayed. As a result, the player's expectation for achievement of a win is enhanced, and the player's passion for gambling can be stirred up.

In relation to the control program for the gaming machine of the invention, the fourth processing operation is characterized in that the sequential rank of the variable symbol determined in the third processing is detected and that the sequential rank of a variable symbol which comes to a standstill after the third processing operation is determined within the range higher or lower than, and including the thus-detected sequential rank, by lottery.

As mentioned above, the sequential rank of the variable symbol that has already been determined is detected. The sequential rank of the next variable symbol which has come to a standstill is determined within the range higher or lower than, and including the detected sequential rank, by lottery. As a result, the player's expectation for achievement of a win is enhanced, and the player's passion for gambling can be stirred up.

According to the control program for the gaming machine of the invention, a gaming machine including a computer displays a plurality of symbols, including variable symbols whose numerical values vary within the range from 1 to “m” (“m” is a natural number), on first through n^{th} columns (N is a natural number). Any symbol is selected from the respective columns by lottery. When the variable symbol has been selected by lottery, a numeral is further selected from the range by lottery. A win or failure is determined in accordance with the thus-determined numerals or a combination thereof. The program causes the gaming machine to perform processing operations; namely, an operation for detecting a numeral of the variable symbol in the sequence for which lottery has been performed immediately beforehand when the variable symbol has been selected for any one of the columns by lottery; an operation for determining a numeral of the variable symbol in the column from a range from the thus-detected numeral to “m” or the range from 1 to the detected numeral; and an operation for determining accomplishment of a win when variable symbols having identical numerals have been selected on all the columns or when the symbols have constituted a predetermined combination.

As mentioned above, when the variable symbol has been selected for any one of the columns by lottery, the numeral of the variable symbol on that column is selected from the range from the numeral of the variable symbol to “m” or the range from 1 to the numeral, by lottery. The player can easily predict numerals which can be determined for that column. Hence, the player's expectation for achievement of a win is enhanced, and the player's passion for gambling can be stirred up.

The control program for the gaming machine is stored in the ROM 31 or the ROM 50 and executed when read by the CPU 30 or the CPU 48. For instance, the control program is recorded on a recording medium, such as CD-ROM or a DVD disk. If the control program is held on a WEB page, the program can be transmitted, whereby the program can be circulated solely.

The foregoing operation of the gaming machine can be expressed as a gaming method. More specifically, a gaming method according to the invention is one in which numerals from 1 to “m” (“m” is a natural number) are displayed on first to N^{th} columns (N is a natural number) and any numeral is selected from the respective columns by lottery and in which a win or failure is determined by the selected numerals or a combination thereof, wherein, when any numeral is selected for the n+1^{th} column (“n” is a natural number; n+1≦N) by lottery, any numeral is selected by lottery from a range from a numeral determined on the n^{th} column (here “n” is a natural number; n≦N) to “m” or a range from one to the numeral determined on the n^{th} column (where “n” is a natural number; n≦N); and a win is achieved when identical numerals have been selected for all the columns or when a specific combination is established by the selected numerals.

As mentioned above, when a numeral is displayed on an active line on the n^{th} column, a numeral to be displayed on the active line in n+1^{th} column (“n” is a natural number) is determined by lottery from a range from the numeral determined on the nth column to “m” or a range from one to the numeral determined on the n^{th} column (“n” is a natural number). The player can easily predict a numeral to be displayed on the n+1th column. As a result, the player's expectation for achievement of a win is enhanced, and the player's passion for gambling can be stirred up.

A gaming method of the invention is one in which a plurality of symbols, including numerals which vary within a range from 1 to “m” (“m” is a natural number), are displayed on first through N^{th} columns (N is a natural number); any symbols are selected for the respective columns; a numeral is further selected from the range when the variable symbol has been selected by lottery; and a win or failure is determined according to the determined numerals or a combination thereof, wherein, when the variable has been selected for any one of the columns by lottery, the numeral of the variable on the column for which a selecting operation has been performed immediately beforehand is detected; a numeral of the variable symbol on the next column is determined by lottery from a range of the detected numeral to “m” or a range from one to the detected numeral; and a win is achieved when identical numerals have been selected for all the columns or when a specific combination is established by the selected numerals.

When the variable symbol has been selected for any one of the columns by lottery, a numeral of the variable symbol is determined by lottery from a range of the detected numeral to “m” or a range from one to the detected numeral. Hence, the player can easily predict a numeral to be displayed on that column. As a result, the player's expectation for achievement of a win is enhanced, and the player's passion for gambling can be stirred up.

As has been described, the method for controlling a gaming machine of the invention comprises:

a first step of successively displaying a plurality of symbols whose sequential relationship has been determined beforehand on symbol display sections, across which a winning line is provided;

a second step of sequentially stopping the variable display operations at certain timings, manually or automatically; and

a third step of alternatively selecting a symbol from the group comprising the symbol stationarily displayed in the second step and a group of symbols satisfying a predetermined condition, the symbol to be stationarily displayed next on any of symbol display regions located on a specific winning line by means of sequential stoppage, so as to follow any of the symbols stationarily displayed in the second step. Processing pertaining to the first through third steps is repeated until the specific symbols are stationarily displayed on all the symbol display sections.

In this way, there is selected a symbol from the group comprising the symbol stationarily displayed in the second step and a group of symbols satisfying a predetermined condition, the symbol to be stationarily displayed next on any of symbol display sections located on a specific winning line by means of sequential stoppage, so as to follow any of the symbols stationarily displayed in the second step. As a result, when a symbol is displayed along an active winning line in any one of the display sections, the player's expectation for a win can be enhanced. When a symbol is stationarily displayed on the winning line in any of the display sections, the player can intuitively predict the probability of achievement of a win from the symbol stationarily displayed on an active winning line. As a result, the player's expectation for achievement of a win is enhanced, and the player's passion for gambling can be stirred up.

What is claimed is:

1. A method of controlling a gaming machine comprising:
a first step of variably displaying a plurality of symbols, whose sequential relationship is previously determined, on a symbol displaying regions across which a winning line is provided;
a second step of stopping the variable display operation at predetermined timings manually or automatically; and
a third step of, subsequently to stopping and displaying a symbol of the symbols on a symbol displaying region of the symbol displaying regions located on a specific winning line, stopping and displaying a following symbol which satisfies a predetermined condition in terms of the sequential relationship with the preceding symbol on a symbol displaying region which is located on the specific winning line other than the preceding symbol displaying region, manually or automatically, wherein the third step is repeated until the symbols are stopped and displayed on all the symbol displaying regions.

2. The method according to claim 1, wherein the predetermined condition is that the sequential rank of the following symbol is higher or lower in rank than that of the preceding symbol.

3. The method according to claim 1, wherein in the third step, the sequential rank of the first symbol which is already stopped is detected, and the second symbol to be stopped next is selected from the group of symbols higher or lower in rank than the detected sequential rank, or equal to the same, by lottery.

4. A method of controlling a gaming machine, in which numerals from 0 to “m” (“m” is a natural number) are displayed on the first to Nth columns (N is a natural number higher than 1) and any symbol is selected for each of the respective columns by lottery, and in which a win or failure is determined by the selected numerals or a combination thereof on a predetermined winning line crossing the respective columns, the method comprising the steps of:
when one of numerals to be located on the winning line at n+1^{th} column (n is a natural number, n+1≦N) is selected by lottery, selecting any numeral by lottery from a range from a numeral determined on the n^{th} column (here “n” is a natural number; n≦N) to m, or a range from one to the numeral determined on the n^{th} column (where “n” is a natural number; n≦N); and
determining a win when identical numerals have been selected for all the columns or when a specific combination is established by the selected numerals.

5. The method according to claim 4, wherein an amount of gaming value to be paid for a player is determined based on a probability of the winning.

6. A method of controlling a gaming machine, comprising:
a first step of successively displaying a plurality of symbols, including variable symbols whose relationship varies within a predetermined sequence range, in symbol display regions, across which a winning line is provided;
a second step of sequentially stopping the successively displaying operations at certain timings, manually or automatically;
a third step of determining the rank of the variable symbol from the sequence range when any one of the variable symbols is stopped and displayed on any of the symbol display regions located on a specific winning line; and
a fourth step of, subsequently to the third step, determining any rank from the rank range satisfying a predetermined condition with respect to the sequential rank of variable symbols that have already been determined through the third processing when the variable symbol is stopped and displayed on another symbol display region which is located on the specific winning line other than the first symbol displaying region,
wherein the second to fourth steps are repeated until the symbols are stopped and displayed on all the symbol displaying regions.

7. The method according to claim 6, wherein the predetermined condition is that the sequential rank of a variable symbol stationarily displayed through the fourth step is higher or lower in rank than that of the variable symbol determined in the third step.

8. The method according to claim 6, wherein, in the fourth step, the sequential rank of the variable symbol determined in the third step is detected, and the sequential rank of a variable symbol which comes to a standstill after the third step is determined within the range higher or lower than the thus-detected rank, or equal to the same, by lottery.

9. The method according to claim 6, wherein an amount of gaming value to be paid for a player is determined based on a probability of the winning.

10. A method for controlling a gaming machine which displays a plurality of symbols, including variable symbols whose numerical values vary within the range from 0 to “m” (“m” is a natural number), on first through Nth columns (N is a natural number higher than 1); selects any one symbol for the respective columns by lottery; further selects a numeral from the range by lottery when the variable symbol has been selected by lottery; and determines a win or failure in accordance with the determined numerals or a combination thereof, the method comprising the step to:
detecting a numeral of the variable symbol in the column for which lottery is performed immediately beforehand when the variable symbol is selected for any one of the columns by lottery;
determining a numeral of the variable symbol in the column from a range from the detected numeral to “m” or the range from 1 to the detected numeral; and
determining achievement of a win when variable symbols having identical numerals is selected on all the columns or when the symbols have constituted a predetermined combination.

11. The method according to claim 10, wherein an amount of gaming value to be paid for a player is determined based on a probability of the winning.

12. A gaming machine comprising:
a display section for successively displaying a plurality of symbols whose sequential relationship is determined beforehand on symbol display sections, across which a winning line is provided;
a stop unit for sequentially stopping the variable display operations at certain timings, manually or automatically; and
a control section for, subsequently to stopping and displaying a symbol on any of the symbol displaying regions located on a specific winning line by the stop unit, alternately selecting a symbol from the group comprising the symbol having been stopped by the stop unit and a group of symbols satisfying a predetermined condition in terms of the sequential relationship, the symbol to be stationarily displayed next on another symbol display region located on the specific winning line,
wherein processing of stopping the variable display and selecting the symbol is repeated until the symbols are stationarily displayed on all the symbol display regions.

13. The gaming machine according to claim 12, wherein the predetermined condition is that the sequential rank of the symbol having been stopped and displayed is higher or lower in rank than that of the symbol which has been stopped already.

14. The gaming machine according to claim 12, wherein the control section detects the sequential rank of the symbol that has already been stopped and displayed by the stop unit, and a symbol to be stopped next is selected from the group of symbols higher or lower in rank than the detected sequential rank, or equal to the same, by lottery.

15. A gaming machine comprising:
display sections for displaying numerals from 0 to “m” (“m” is a natural number) on first to n^{th} columns (N is a natural number higher than 1);
a lottery device for selecting any symbols for the respective columns by means of lottery; and
a control section for determining a win or failure in accordance with the selected numerals or a combination thereof on a specific winning line crossing the respective columns, wherein
the lottery device selects any numeral to be located on the specific winning line by lottery from a range from a numeral determined on the nth column (here “n” is a natural number; n≦N) or a range from one to the numeral determined on the nth column (where “n” is a natural number; n≦N) when any one is selected from the n+1th column (“n” is a natural number; n+1≦N) by lottery; and
the control section determines a win when identical numerals have been selected for all the columns on the specific winning line or when a specific combination is established by the numerals selected for the respective column.

16. A gaming machine, comprising:
display sections for successively displaying a plurality of symbols, including variable symbols whose relationship varies within a predetermined sequence range, a wining line being provided across the display sections;
a stop unit for sequentially stopping the successively displaying operations at certain timings, manually or automatically; and
a control section for determining the sequential rank of the variable symbols from the sequence range when any one of the variable symbols are stationarily displayed in any of the symbol display sections located on a specific winning line when any of the variable symbols is stopped and displayed on any of the symbol display regions located on a specific winning line by the stop unit, and selecting the sequential ranks of variable symbols that have already been determined through the third processing and the rank range satisfying a predetermined condition from the sequence range when the variable symbol is stationarily displayed in another symbol display area sharing a winning line identical with the specific winning line,
wherein processing of stopping variable display and determining the sequential ranks is repeated until the symbol is stopped and displayed in all the symbol display sections.

17. The gaming machine according to claim 16, wherein the predetermined condition is that the rank of a variable symbol to be stationarily displayed is higher in rank than or equal to the determined variable symbol or lower in rank than or equal to the same.

18. The gaming machine according to claim 15, wherein the control section detects the sequential rank of the variable symbol determined already, and determines the sequential rank of a variable symbol which comes to a standstill after the variable symbol whose sequential rank is already determined is determined within the range higher or lower than the thus-detected sequential rank, including the same, by lottery.

19. A gaming machine comprising:
a display section for displaying a plurality of symbols, including variable symbols whose numerical values vary within the range from 0 to “m” (“m” is a natural number), on first through Nth columns (N is a natural number higher than 1);
a lottery device for selecting any one symbol for each the respective columns by lottery and further selecting a numeral from the range by lottery when the variable symbol has been selected by lottery; and
a control section for determining a win or failure in accordance with the determined numerals or a combination thereof,
wherein the lottery device detects a numeral of the variable symbol in the column for which lottery has been performed immediately before the variable symbol has been selected for any one of the columns by lottery and determines a numeral of the variable symbol in the column from a range from the detected numeral to “m” or the range from 1 to the detected numeral, and
wherein the control section determines achievement of a win when variable symbols having identical numerals are selected on all the columns crossing a specific winning line or when value of the variable symbols selected for respective columns constitutes a predetermined combination.

20. The gaming machine according to claim 19, wherein an amount of gaming value to be paid for a player is determined based on a probability of the winning.

21. A gaming machine comprising:
a display section for successively displaying a plurality of symbols whose sequential relationship is determined beforehand on symbol display sections, across which a winning line is provided;
a stop unit for sequentially stopping the variable display operations at certain timings, manually or automatically; and
a control section for, subsequently to stopping and displaying a symbol on any of the symbol displaying regions located on a specific winning line by the stop unit, alternately selecting a symbol from the group comprising the symbol having been stopped by the stop unit and a group of symbols satisfying a predetermined condition in terms of the sequential relationship, the symbol to be stationarily displayed next on another symbol display region located on the specific winning line,
wherein processing of alternately selecting the symbol to be displayed on the symbol display region is repeated until the symbols are stopped and displayed on all the symbol display regions.

22. A gaming machine comprising:
display sections for successively displaying a plurality of symbols, including variable symbols whose relationship varies within a predetermined sequence range, a wining line being provided across the display sections;
a stop unit for sequentially stopping the successively displaying operations at certain timings, manually or automatically; and
a control section for alternatively selecting a sequential rank of a variable symbol to be stopped at any one of the symbol display region located on a specific winning line, and alternatively selecting the sequential rank of a variable symbol to be stopped at another symbol display region sharing the specific winning line from the group comprising the sequential rank of the variable symbol to be stopped and the sequence range satisfying a predetermined condition in terms of the sequential relationship,
wherein processing of alternatively selecting symbol is repeated until the symbol is stopped and displayed in all the symbol display sections.

23. A computer readable recording medium for causing a gaming machine including a computer to execute:
first processing for variably displaying a plurality of symbols, whose sequential relationship is previously determined, on a symbol displaying regions across which a winning line is provided;
second processing for stopping the variable display operation at predetermined timings manually or automatically; and
third processing for, subsequently to stopping and displaying a symbol of the symbols on a symbol displaying region of the symbol displaying regions located on a specific winning line, stopping and displaying a following symbol which satisfies a predetermined condition in terms of the sequential relationship with the preceding symbol on a symbol displaying region which is located on the specific winning line other than the preceding symbol displaying region, manually or automatically,
wherein the third processing is repeated until the symbols are stopped and displayed on all the symbol displaying regions.
